(19) United States
(12) Patent Application Publication
(10) Pub. No.: US 2008/0202295 A1
(43) Pub. Date: Aug. 28, 2008

(54) Screw driving tool for repairing spectacles

(76) Inventor: Kung-Ping Su, Taipei (TW)

Correspondence Address: BRUCE H. TROXELL, SUITE 1404, 5205 LEESBURG PIKE, FALLS CHURCH, VA, 22041, US

(21) Appl. No.: 11/711,137

(22) Filed: Feb. 27, 2007

(51) Int. Cl. B25B 15/00; B25B 23/08

(52) U.S. Cl. 81/439; 81/121.1

(57) ABSTRACT

A screw driving tool is used to stably clamp a tiny screw and tighten the clamped screw into a screw hole on a spectacles frame for repairing the spectacles. The screw driving tool includes a screwdriver and a clamping sleeve consisting of a rigid outer layer and an elastically compressible inner layer. The clamping sleeve has a first end, into which a head of the screw for spectacles may be extended, and a second end, into which a blade of the screwdriver is extended. The screw head extended into the first end of the clamping sleeve is clamped thereto by the elastically compressive inner layer of the clamping sleeve, so that the tiny screw can be easily aligned with the screw hole on the spectacles and tightened using the screwdriver.

### FIELD OF THE INVENTION

The present invention relates to a screw driving tool that may stably clamp a tiny screw and tighten the clamped screw into a screw hole on a spectacles frame for repairing the spectacles conveniently.

### BACKGROUND OF THE INVENTION

Most people in the modern society, including students, the general public, and the retired, wear spectacles for different reasons. Some students wear reading glasses due to watching TV too much or reading under insufficient light source frequently. Some people wear reading glasses because their works require highly precise visual observation or watching monitors over prolonged time, while others wear reading glasses due to hereditary myopia. The retired generally require a pair of distant glasses. Without eyeglasses, these people would have difficulties in reading or working easily. It is therefore necessary for these people to always keep their spectacles in a good condition for service.

There are many screws on the spectacles for fastening the rim, temples, and/or nose pads in place. These screws tend to become loosened to result in useless spectacles. Moreover, these screws are very small in size and require a special small-size screwdriver to tighten or loosen them.

In developed European and American countries, people like to handle many things by DIY (Do It Yourself) to save the very expensive labor cost, and most families have small screwdrivers prepared for repairing spectacles by themselves. However, either the common spectacles wearers or the professional spectacles dealers have difficulties in quickly aligning the tiny spectacles screw with the screw hole on the spectacles before tightening the screw. People tend to get ill-tempered when they fail to tighten the small spectacles screw with the screwdriver and a lot of time has been wasted.

It is therefore tried by the inventor to develop a screw driving tool for repairing spectacles, so that people may use it to easily clamp a tiny screw and align and tighten the clamped screw into a corresponding screw hole on the spectacles within a short time.

### SUMMARY OF THE INVENTION

A primary object of the present invention is to provide a screw driving tool for repairing spectacles. The screw driving tool may stably clamp a tiny screw, so that the clamped screw can be quickly aligned with and tightened into a screw hole on a spectacles frame.

To achieve the above and other objects, the screw driving tool for repairing spectacles according to the present invention includes a screwdriver and a clamping sleeve consisting of a rigid outer layer and an elastically compressible inner layer. The clamping sleeve has a first end, into which a head of the screw for spectacles may be extended; and a second end, into which a blade of the screwdriver is extended. The screw head extended into the first end of the clamping sleeve is clamped thereto by the elastically compressive inner layer of the clamping sleeve, so that the tiny screw can be easily aligned with the screw hole on the spectacles and tightened using the screwdriver.

In the present invention, the clamping sleeve has an opening at the first end having a diameter allowing the head of the screw to easily move thereinto, and the elastically compressible inner layer has an inner diameter slightly smaller than an outer diameter of the screw head to effectively clamp the screw head thereto.

In the present invention, the screwdriver includes a handle behind the blade, and the handle is provided at a predetermined position with an openably closed inner space for holding spare spectacles screws therein.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a screw driving tool for repairing spectacles according to a first embodiment of the present invention;

FIG. 2 is an exploded view of FIG. 1;

FIG. 3 is a longitudinal sectional view showing the screw driving tool of FIG. 1 is used to tighten a screw of a first size;

FIG. 4 is a longitudinal sectional view showing the screw driving tool of FIG. 1 is used to tighten a screw of a second size;

FIG. 5 is a perspective view of a clamping sleeve included in the screw driving tool according to a second embodiment of the present invention;

FIG. 6 is a longitudinal sectional view of the clamping sleeve of FIG. 5; and

FIG. 7 is a screw driving tool for repairing spectacles according to a third embodiment of the present invention.

### DETAILED DESCRIPTION OF THE PREFERRED EMBODIMENTS

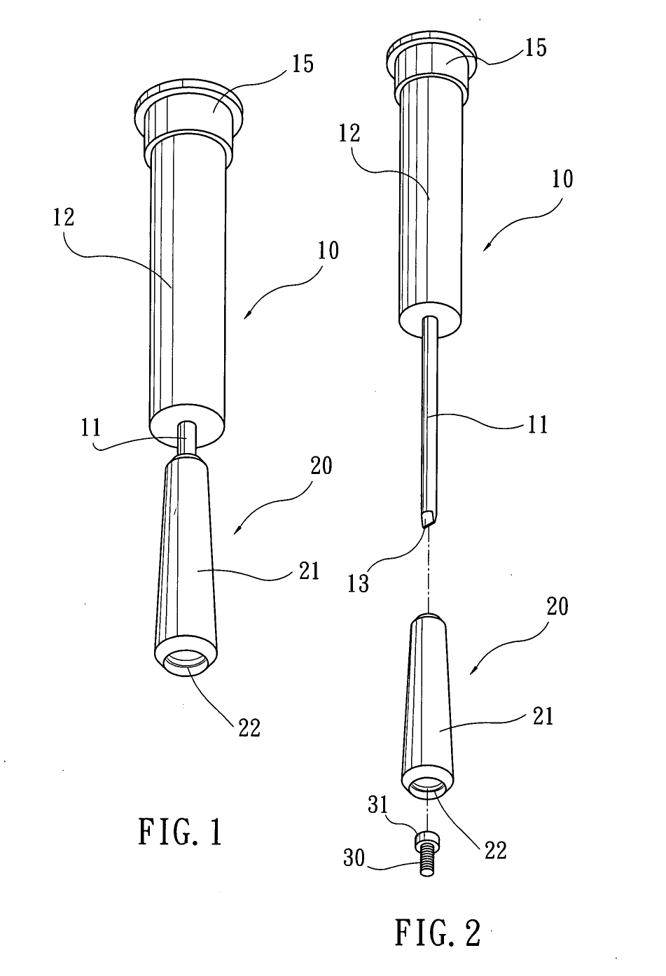

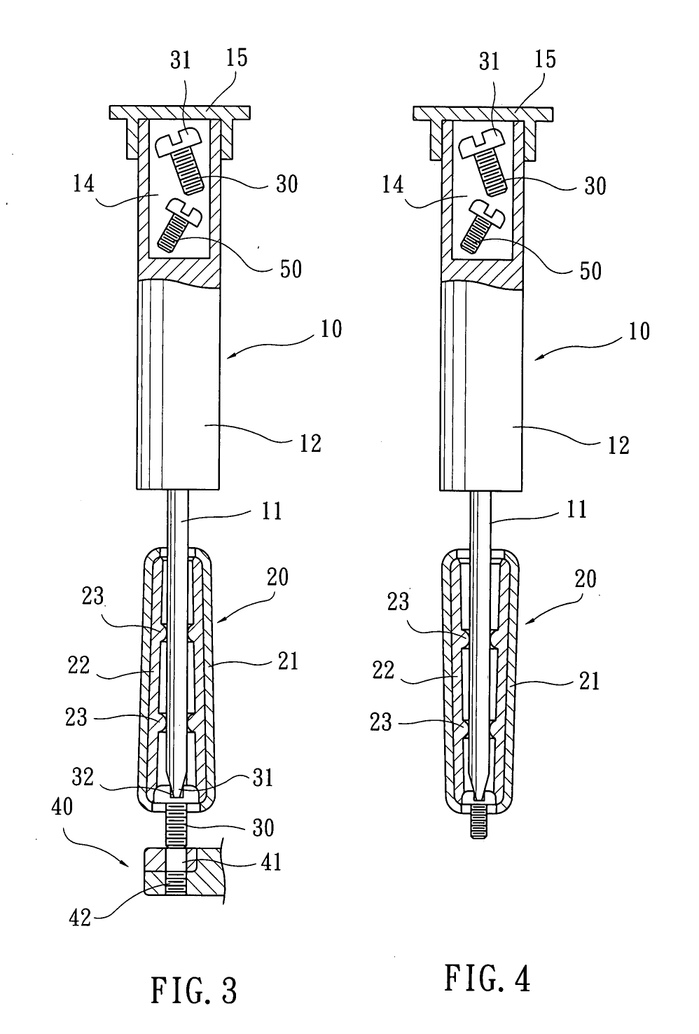

Please refer to FIGS. 1 and 2 that are assembled and exploded perspective views, respectively, of a screw driving tool for repairing spectacles according to a first embodiment of the present invention. As shown, the screw driving tool in the first embodiment includes a screwdriver 10 and a clamping sleeve 20. The screwdriver 10 has a size similar to that of general spectacles repairing screwdrivers. The screwdriver 10 includes a blade 11 and a handle 12 forming a front and a rear part, respectively, of the screwdriver 10. The blade 11 has a tip 13 formed at a front end thereof. The tip 13 may be a cabinet tip or a Philip head tip. The clamping sleeve 20 internally defines a longitudinally extended bore, and includes a rigid outer layer 21 and an elastically compressible inner layer 22. The clamping sleeve 20 has a first end, into which a head 31 of a screw 30 of a first size may be extended, and a second end, into which the blade 11 of the screwdriver 10 may be extended. With the elastically compressible inner layer 22 of the clamping sleeve 20, the screw head 31 may be clamped to the first end of the clamping sleeve 20, as shown in FIG. 3.

To use the screw driving tool of the present invention to tighten the screw 30 into a mounting hole 41 on a spectacles frame 40 as shown in FIG. 3, first insert the head 31 of the screw 30 into the first end of the clamping sleeve 20, so that the screw head 31 is elastically clamped to the first end of the clamping sleeve 20 by the elastic inner layer 21 thereof. Then, hold and control the clamping sleeve 20 to align the screw 30 with the mounting hole 41 on the spectacles frame 40, and slightly turn the screwdriver 10, the blade 11 of which is extended into the longitudinal bore of the clamping sleeve 20, for the tip 13 of the blade 11 to align and engage with a slot 32 formed on the screw head 31. Thereafter, the screw 30 may be turned with the screwdriver 10 to screw into a screw hole 42 at a bottom of the mounting hole 41. When the screw 30 is observed as being turned, it means the tip 13 has been correctly engaged with the slot 32 on the screw head 31. To enable more convenient manipulation of the screw driving tool of the present invention, the clamping sleeve 20 may have rigid outer layer 21 and elastic inner layer 22 made of a transparent material, so that a user may clearly see and easily determine whether the tip 13 has been correctly engaged with the slot 32 on the screw head 31.

An inner diameter of the elastic inner layer 22 at the first end of the clamping sleeve 20 is slightly smaller than an outer diameter of the head 31 of the screw 30. When the head 31 of the screw 30 is moved into the elastic inner layer 22, the elastic inner layer 22 is slightly compressed by the screw head 31 to clamp around the screw head 31. However, an opening of the elastic inner layer 22 near the first end of the outer layer 21 has a size similar to that of the screw head 31, allowing the screw head 31 to be easily inserted into the elastic inner layer 22. The elastic inner layer 22 of the clamping sleeve 20 is provided on an inner wall surface with two radially inward protruded annular flanges 23 spaced from each other by a predetermined distance. Inner diameters of the two annular flanges 23 are slightly smaller than an outer diameter of the blade 11 of the screwdriver 10. When the blade 11 is extended into the clamping sleeve 20 via the second end thereof, the blade 11 is elastically surrounded by the two flanges 23 and accordingly stably held in the elastic inner layer 22 to associate the screwdriver 10 with the clamping sleeve 20 to form an integral body, making the screw driving tool of the present invention very convenient for use. Wherein, the elastic inner layer 22 may be made of a rubber or a silicon rubber material.

Please refer to FIGS. 3 and 4 at the same time. The screws for use with general spectacles can be divided into two sizes. In the illustrated embodiments of the present invention, the screw having a first or large size is denoted by reference numeral 30, while the screw having a second or small size is denoted by reference numeral 50. In response to the two different sizes of screws 30, 50 for spectacles, the clamping sleeve 20 of the present invention is designed to have different diameters at the front and the second end thereof, so that only one single clamping sleeve 20 may be used to clamp screws of two different sizes. In FIG. 3, the clamping sleeve 20 is connected to the blade 11 of the screwdriver 10 with the first end having a larger diameter facing forward to clamp the screw 30 having the first or large size; and in FIG. 4, the clamping sleeve 20 is connected to the blade 11 of the screwdriver 10 with the second end having a smaller diameter facing forward to clamp the screw 5Q having the second or small size.

The screw driving tool of the present invention not only facilitates easy tightening of the tiny screws 30, 50 into a mounting hole 41 on a spectacle frame 40, but also allows easy loosening of the tiny screws 30, 50 from the spectacle frame 40. The screw 30, 50 loosened from the spectacle frame 40 is still clamped to the clamping sleeve 20 and prevented from missing unexpectedly.

The handle 12 of the screwdriver 10 is provided at a top with an open-topped internal space 14 that is openably closed with a cap 15 for holding spare screws 30, 50 and some other small spectacles accessories therein, such as nose pads (not shown). When any of the screws 30, 50 on the spectacle frame 40 is loosened and missed, a user may conveniently open the internal space 14 on the handle 12 of the screwdriver 10 and remove a suitable screw 30 or 50 therefrom for tightening to the spectacle frame 40 at a desired position.

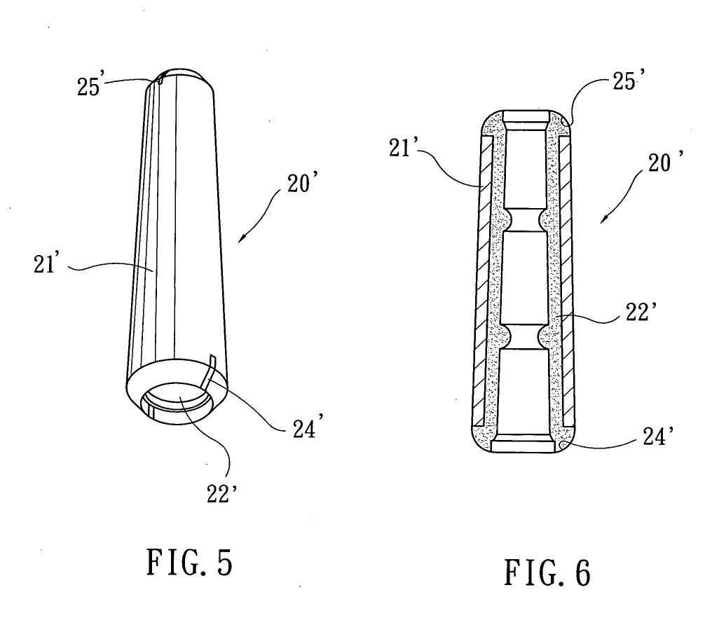

FIGS. 5 and 6 are perspective and longitudinal sectional views, respectively, of a clamp sleeve 20′ included in the screw driving tool according to a second embodiment of the present invention. The clamping sleeve 20′ is different from the clamping sleeve 20 in that a rigid outer layer 21′ of the clamping sleeve 20′ is provided at the first and the second end with two diametrically opposite slits 24′, 25′ each, so that the first and the second end of the clamping sleeve 20′ are elastically expandable. As a result, the clamping sleeve 20′ may be used to stably clamp screws having a head slightly larger than the inner diameter of an elastic inner layer 22′ thereof. As can be clearly seen from FIG. 6, the slits 24, 25 at the two ends of the rigid outer layer 21′ of the clamping sleeve 20′ are also filled in with the material of the elastic inner layer 22′, giving the whole clamping sleeve 20′ a complete appearance.

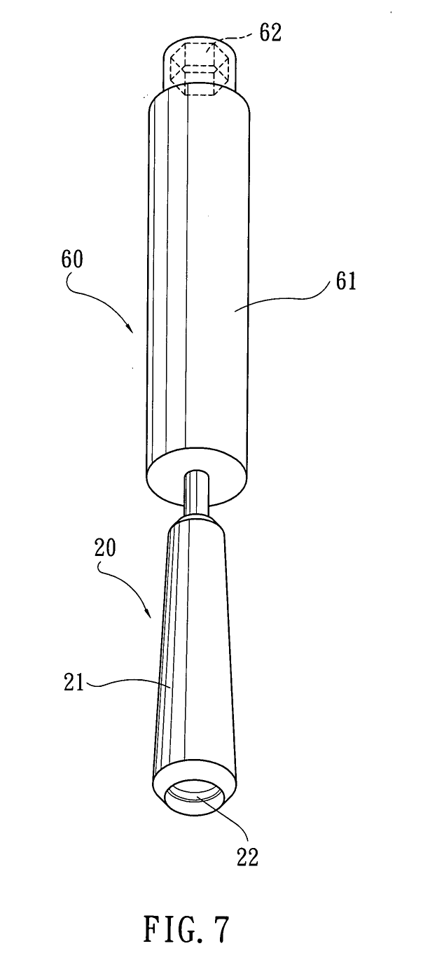

On some other commercial available spectacles, there are also screws with a hexagonal head. FIG. 7 shows a screw driving tool according to a third embodiment of the present invention. The screw driving tool in the third embodiment shown in FIG. 7 includes a screwdriver 60 having a handle 61, and a clamping sleeve 20 similar to that in the first embodiment. The handle 61 of the screwdriver 60 is provided at a rear free end with a hexagonal cavity for conveniently tightening a screw with a hexagonal screw head.

The screw driving tool for repairing spectacles according to the present invention enables a spectacles wearer to conveniently tightening and loosening tiny screws to and from a spectacle frame. Moreover, the screw driving tool for repairing spectacles according to the present invention has simple structure that may be manufactured at low cost while effectively increases the function of a screwdriver, and is therefore a practical and commercially valuable design.

What is claimed is:

1. A screw driving tool for repairing spectacles, comprising:
a screwdriver including a blade and a handle forming a front and a rear part of the screwdriver, and the blade has a tip formed at a front end thereof; and
a clamping sleeve internally defining a longitudinally extended bore, and including a rigid outer layer and an elastically compressible inner layer; the clamping sleeve having a first end, into which a head of a screw is extended, and a second end, into which the blade of the screwdriver is extended; and the head of the screw extended into the first end of the clamping sleeve being clamped thereto by the elastically compressive inner layer of the clamping sleeve.

2. The screw driving tool for repairing spectacles as claimed in claim 1, wherein the first and the second end of the clamping sleeve have different internal diameters.

3. The screw driving tool for repairing spectacles as claimed in claim 1, wherein the rigid outer layer of the clamping sleeve is provided at two openings at the first and the second end of the clamping sleeve with two diametrically opposite slits each.

4. The screw driving tool for repairing spectacles as claimed in claim 3, wherein the slits on the rigid outer layer of the clamping sleeve are filled in with a material of the elastically compressible inner layer.

5. The screw driving tool for repairing spectacles as claimed in claim 1, wherein the elastically compressible inner layer of the clamping sleeve is provided on an inner wall surface with at least one radially inward protruded annular flange; and the annular flange having an inner diameter slightly smaller than an outer diameter of the blade of the screwdriver to thereby stably clamp the blade in the longitudinal bore of the clamping sleeve.

6. The screw driving tool for repairing spectacles as claimed in claim 1, wherein the handle of the screwdriver is provided with an openably closed inner space for holding spare spectacles screws.

7. The screw driving tool for repairing spectacles as claimed in claim 1, wherein the handle of the screwdriver is provided at a rear free end with a hexagonal cavity.

8. A clamping sleeve associated with a screwdriver for repairing spectacles, comprising a sleeve body internally defining a longitudinal bore, and including a rigid outer layer and an elastically compressible inner layer; the sleeve body having a first end, into which a head of a screw for spectacles may be extended, and a second end, into which a blade of the screwdriver is extended; and the head of the screw extended into the first end of the sleeve body being clamped thereto by the elastically compressive inner layer of the sleeve.

9. The clamping sleeve associated with a screwdriver for repairing spectacles as claimed in claim 8, wherein the first and the second end of the sleeve body have different internal diameters.

10. The clamping sleeve associated with a screwdriver for repairing spectacles as claimed in claim 8, wherein the elastically compressible inner layer of the sleeve body is provided on an inner wall surface with at least one radially inward protruded annular flange; and the annular flange having an inner diameter slightly smaller than an outer diameter of the blade of the screwdriver to thereby stably clamp the blade in the longitudinal bore of the sleeve body.

11. The clamping sleeve associated with a screwdriver for repairing spectacles as claimed in claim 8, wherein the rigid outer layer of the sleeve body is provided at two openings at the first and the second end of the sleeve body with two diametrically opposite slits each.

12. The clamping sleeve associated with a screwdriver for repairing spectacles as claimed in claim 11, wherein the slits on the rigid outer layer of the sleeve body are filled in with a material of the elastically compressible inner layer.
